(19) United States
(12) Patent Application Publication
(10) Pub. No.: US 2022/0333800 A1
(43) Pub. Date: Oct. 20, 2022

(54) AIR FILTERING DEVICE

(71) Applicant: Joy Design Company Limited, Taichung City (TW)

(72) Inventor: Yi-Chen LIN, TAICHUNG CITY (TW)

(21) Appl. No.: 17/232,542

(22) Filed: Apr. 16, 2021

(51) Int. Cl. F24F 8/192; B03C 3/38

(52) U.S. Cl. CPC F24F 8/194; B03C 3/38

(57) ABSTRACT

An air filtering device is provided, including: a plurality of metal nets, arranged in interval in a filtering path, respectively connected to a pole of at least one high-voltage power source to provide electric fields, adjacent two of the plurality of metal nets having opposite polarities; wherein at least one of the plurality of metal nets is of an electric characteristic which is time-variant relative to a constant reference level so that the electric field of the at least one of the plurality of metal nets is time-variant.

### BACKGROUND OF THE INVENTION

### Field of the Invention

The present invention relates to an air filtering device.

Description of the Prior Art

Most creatures in the world need oxygen to survive; however, there are often other substances in the air, such as droplets, dust, pollen, haze, bacteria, viruses, etc. When these substances enter the human body, it often leads to respiratory or cardiopulmonary diseases, such as flu, whooping cough, pneumonia, etc. Therefore, more and more places have be equipped with air filters to filter air, in order to prevent particulate matters, bacteria, viruses, germs or the like into the human body.

Most conventional air filtration methods nowadays use physical filtration. For example, the HEPA filter is used to intercept particulate matters by its tiny pores. However, the HEPA filter does not have effective filtering performance for viruses, bacteria and odors, and an active carbon filtering layer, sterilizing member and formaldehyde filtering layer have to be additionally introduced into the filter, which results in the disadvantages of many components, complex structure and high replacement/production cost.

The present invention is, therefore, arisen to obviate or at least mitigate the above-mentioned disadvantages.

### SUMMARY OF THE INVENTION

The main object of the present invention is to provide an air filtering device with time-variant electric characteristic, which provides good effects in filtration and sterilization.

To achieve the above and other objects, an air filtering device is provided, including: a plurality of metal nets, arranged in interval in a filtering path, respectively connected to a pole of at least one high-voltage power source to provide electric fields, adjacent two of the plurality of metal nets having opposite polarities; wherein at least one of the plurality of metal nets is of an electric characteristic which is time-variant relative to a constant reference level so that the electric field of the at least one of the plurality of metal nets is time-variant.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a partial cross-sectional view of the first preferable embodiment of the present invention;

FIG. 3 is a drawing showing arrangement of metal nets and electric discharging members according to the first preferable embodiment of the present invention;

FIG. 4 is a drawing showing action of metal nets according to a second preferable embodiment of the present invention;

FIG. 5 is a voltage-time diagram according to the first preferable embodiment of the present invention; and

FIG. 6 is a voltage-time diagram according to the second preferable embodiment of the present invention.

### DETAILED DESCRIPTION OF THE PREFERRED EMBODIMENTS

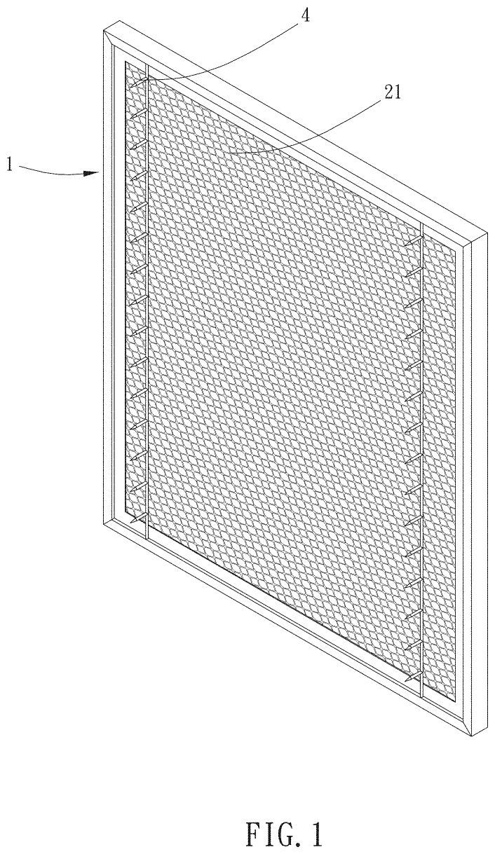

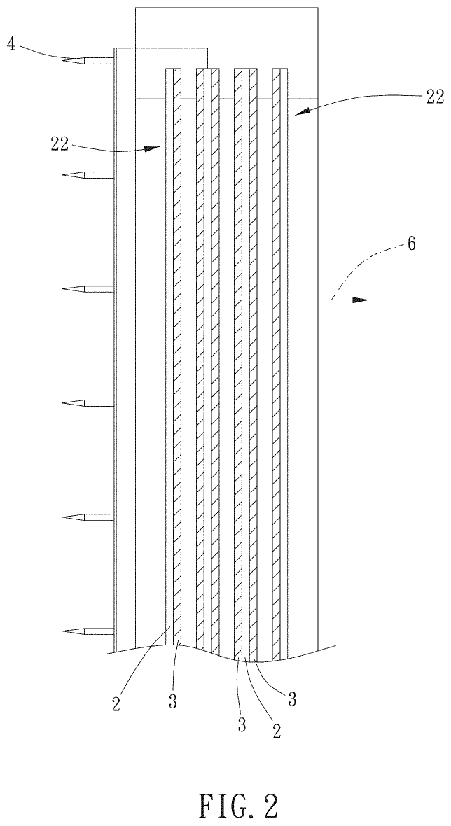

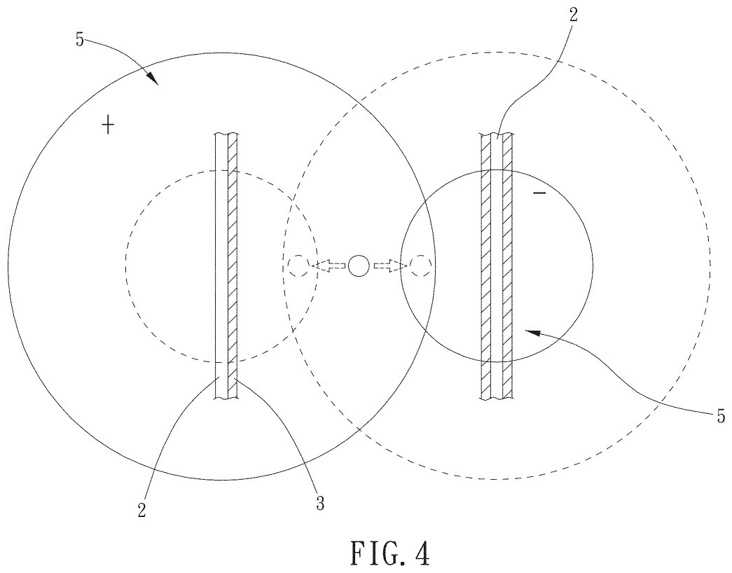

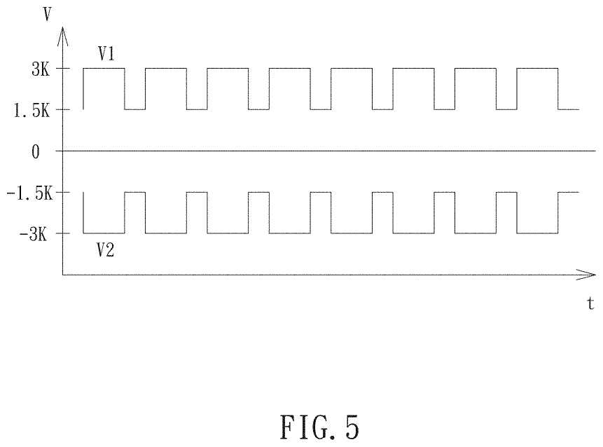

Please refer to FIGS. 1 to 5 for a first preferable embodiment of the present invention. An air filtering device 1 of the present invention includes a plurality of metal nets 2. The plurality of metal nets 2 are arranged in interval in a filtering path 6, and the plurality of metal nets 2 are respectively connected to a pole of at least one high-voltage power source to provide electric fields. Adjacent two of the plurality of metal nets 2 have opposite polarities. For example, the polarities of adjacent two of the plurality of metal nets 2 are positive and negative, respectively. At least one of the plurality of metal nets 2 is of an electric characteristic which is time-variant relative to a constant reference level so that the electric field 5 of the at least one of the plurality of metal nets is time-variant.

The electric characteristic includes at least one of voltage and electric phase. Specifically, as the electric characteristic is set to be the voltage, the voltage of at least one of the adjacent two of the plurality of metal nets is provided in wave-signal form, such as in square wave, triangle wave or trapezoidal wave form. By changing of the voltage, corona discharge, which can causes ozone due to high voltage for a period of time, can be effectively avoided.

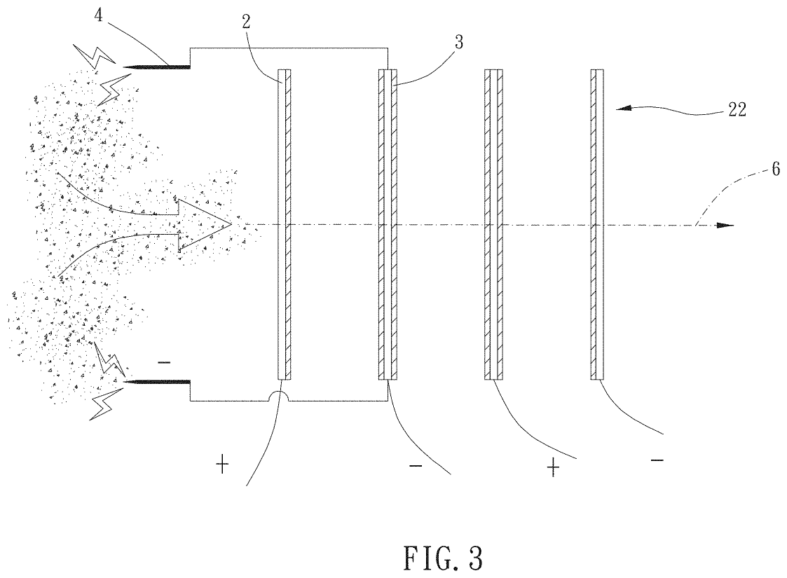

Specifically, as shown in FIGS. 3-5, the voltages of the adjacent two of the plurality of metal nets 2 are provided in wave-signal form with a phase difference therebetween, and the electric fields 5 of the adjacent two of the plurality of metal nets 2 are variant and overlap with each other. The electric fields 5 of the adjacent two of the plurality of metal nets 2 variantly and alternative change with different ranging areas. As a result, particulate matters, viruses and/or germs can be effectively attracted between the adjacent two of the plurality of metal nets 2 since the polarities of the adjacent two of the plurality of metal nets 2 change time-variantly. The outer layer portion of viruses and/or germs can be easily destroyed by the electric field which is time-variant. In the first preferable embodiment, the voltages of the plurality of metal nets 2 are provided in wave-signal form, which provides the best performance.

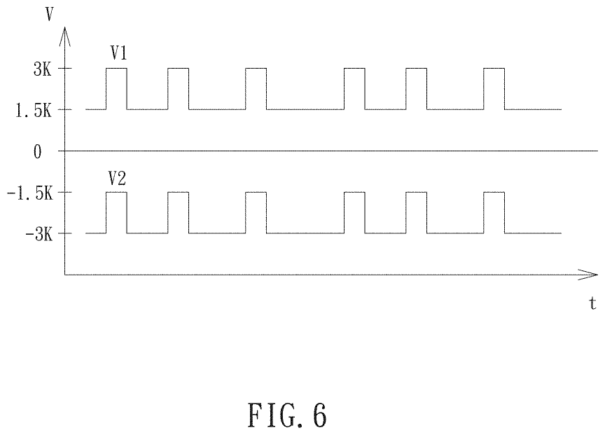

In a second preferable embodiment as shown in FIG. 6, the difference from the first preferable embodiment is that the electric characteristic is set to be the electric phase, and the electric phase of at least one of the adjacent two of the plurality of metal nets is time-variant. Through change of cycle or frequency of the electric phase, it achieves the best performance the same as that of the first preferable embodiment.

Please refer to FIGS. 1 to 5, in the first preferable embodiment, each of the plurality of metal nets 2 preferably includes a plurality of meshes 21, and the number of the plurality of meshes 21 of each of the plurality of metal nets 2 is at least greater than 50, which ensures good physical filtering of the meshes 21 of each of the plurality of metal nets 2. Preferably, at least one of two opposite sides 22 of each of the plurality of metal nets 2 is coated with a filtering layer 3 which is non-conductive, which provides good physical filtering and insulation. The filtering layer 3 may include a non-woven or melt-blown fabric.

The air filtering device 1 further includes at least one electric discharging member 4, the at least one electric discharging member 4 is located at a leading end of the filtering path 6 and outside the plurality of metal nets 2; the at least one electric discharging member 4 and a first one of the metal nets 2 adjacent to the at least one electric discharging member 4 have opposite polarities, and the at least one electric discharging member 4 is configured to discharge matters in the air so that the matters discharged is attractable by the first one of the metal nets 2 adjacent to the at least one electric discharging member 4 and flow along the filtering path 6 to be between the plurality of metal nets 2, so that the air is filtered and cleaned.

In this embodiment, the at least one electric discharging member 4 is column-shaped, the at least one electric discharging member 4 includes at least one of metal needle, carbon brush and semiconductor column. The at least one electric discharging member 4 and a second one of the metal nets 2 are electrically connected and have the same electric characteristic, wherein the at least one electric discharging member 4 and the second one of the metal nets 2 are located at two opposite sides of the first one of the metal nets 2. The at least one electric discharging member 4 and the second one of the metal nets 2 have the same electric characteristic, which ensures the at least one electric discharging member 4 and the first one of the plurality of metal nets 2 have opposite polarities for attraction, and are connected the same power source for simple configuration.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An air filtering device, including:
a plurality of metal nets, arranged in interval in a filtering path, respectively connected to a pole of at least one high-voltage power source to provide electric fields, adjacent two of the plurality of metal nets having opposite polarities;
wherein at least one of the plurality of metal nets is of an electric characteristic which is time-variant relative to a constant reference level so that the electric field of the at least one of the plurality of metal nets is time-variant.

2. The air filtering device of claim 1, wherein the electric characteristic includes at least one of voltage and electric phase.

3. The air filtering device of claim 2, wherein as the electric characteristic is set to be the voltage, the voltage of at least one of the adjacent two of the plurality of metal nets is provided in wave-signal form.

4. The air filtering device of claim 3, wherein the voltages of the adjacent two of the plurality of metal nets are provided in wave-signal form with a phase difference therebetween, and the electric fields of the adjacent two of the plurality of metal nets are variant and overlap with each other.

5. The air filtering device of claim 2, wherein the electric characteristic is set to be the electric phase, and the electric phase of at least one of the adjacent two of the plurality of metal nets is time-variant.

6. The air filtering device of claim 1, wherein each of the plurality of metal nets includes a plurality of meshes, and the number of the plurality of meshes of each of the plurality of metal nets is at least greater than 50.

7. The air filtering device of claim 1, wherein at least one of two opposite sides of each of the plurality of metal nets is coated with a filtering layer which is non-conductive.

8. The air filtering device of claim 1, wherein at least one electric discharging member is located at a leading end of the filtering path and outside the plurality of metal nets; the at least one electric discharging member and a first one of the metal nets adjacent to the at least one electric discharging member have opposite polarities, and the at least one electric discharging member is configured to discharge matters in the air so that the matters discharged is attractable by the first one of the metal nets adjacent to the at least one electric discharging member and flow along the filtering path to be between the plurality of metal nets.

9. The air filtering device of claim 8, wherein the at least one electric discharging member and a second one of the metal nets are electrically connected and have the same electric characteristic, and wherein the at least one electric discharging member and the second one of the metal nets are located at two opposite sides of the first one of the metal nets.

10. The air filtering device of claim 4, wherein each of the plurality of metal nets includes a plurality of meshes, and the number of the plurality of meshes of each of the plurality of metal nets is at least greater than 50; at least one of two opposite sides of each of the plurality of metal nets is coated with a filtering layer which is non-conductive; at least one electric discharging member is located at a leading end of the filtering path and outside the plurality of metal nets; the at least one electric discharging member and a first one of the metal nets adjacent to the at least one electric discharging member have opposite polarities, and the at least one electric discharging member is configured to discharge matters in the air so that the matters discharged is attractable by the first one of the metal nets adjacent to the at least one electric discharging member and flow along the filtering path to be between the plurality of metal nets; the voltage of each of the plurality of metal nets is provided in wave-signal form; the at least one electric discharging member is column-shaped; the at least one electric discharging member includes at least one of metal needle, carbon brush and semiconductor column; the filtering layer includes a non-woven or melt-blown fabric.
